(19) United States
(12) Patent Application Publication
(10) Pub. No.: US 2008/0053094 A1
(43) Pub. Date: Mar. 6, 2008

(54) System for providing continuous electric power from solar energy

(75) Inventor: William R. Palmer, Melbourne, FL (US)

Correspondence Address: HARRIS CORPORATION;C/O DARBY & DARBY PC, P.O. BOX 770, CHURCH STREET STATION, NEW YORK, NY, 10008-0770, US

(73) Assignee: HARRIS CORPORATION, Melbourne, FL (US)

(21) Appl. No.: 11/516,114

(22) Filed: Sep. 6, 2006

(51) Int. Cl. F03G 6/00

(52) U.S. Cl. 60/641.8

(57) ABSTRACT

A system (112) for generating electric power from solar energy is provided. The system is comprised of a solar concentrator (302) formed of an optically reflective material having a curved surface. The curved surface defines a focal center or a focal line toward which light incident on the curved surface is reflected. A thermal energy collector (310) is positioned substantially at the focal center or along the focal line. A thermal energy converter (116-1) is operatively coupled to the thermal energy collector. The thermal energy converter is configured for converting thermal energy collected by the thermal energy collector to electric power. A fuel based power generation system (128) is also provided. The fuel based power generation system is operatively connected to the thermal energy converter. The thermal energy converter provides electric power to the fuel based power generation system for generating a fuel and an oxidizer when the thermal energy collector is exposed to solar radiation.

### BACKGROUND OF THE INVENTION

1. Statement of the Technical Field

The invention concerns power systems, and more particularly, solar power systems that can convert solar energy into electric power.

2. Description of the Related Art

There are currently in use a wide variety of systems and methods for utilizing solar power as a source of energy. For example, photovoltaic systems are widely known for converting sunlight into electricity. Another common type of system is the solar trough. The solar trough is a type of solar thermal system where sunlight is concentrated by a curved reflector onto a pipe containing a working fluid that can be used for process heat or to produce electricity. Solar thermal electric power plants using solar trough technology are well known.

A variation of the solar trough technology is a photovoltaic concentrator system. The photovoltaic concentrator system uses sun-tracking mirrors that reflect light onto a receiver lined with photovoltaic solar cells. The mirrors concentrate the incident solar energy on the solar cells so that they are illuminated with approximately 25 times normal solar concentration. Such systems can convert at an efficiency of about 20%. The balance of the solar energy is converted into heat. However, the solar cells have an upper temperature limit of about 200° C. Accordingly, excess heat must be removed. Typically, this is accomplished by means of a cooled heat exchanger attached to the photovoltaic solar cells. For example, the photovoltaic cells can be provided with an integrated passive heat sink to maintain the solar cells at a moderate temperature.

Despite the advantages offered by the foregoing systems, they still have not achieved a level of efficiency necessary for certain applications. For example, near space vehicles may be used in different applications, such as monitoring troops, surveillance of combatants, delivery of communications, and/or disaster area monitoring. Future near space vehicles are envisioned to travel between 60,000 feet to 80,000 feet above sea level. Consequently, near space vehicles will travel above the reach of conventional weapon systems and free from the threat of weather interference.

Current concept designs of long endurance near space vehicles are limited by their payload and propulsion capabilities. One limitation comes from a near space vehicle's dependency on fuel to power propulsion systems and onboard components, such as radars, sensors, imaging devices, control systems, and radio transmitters. A large amount of weight is invested to carrying a sufficient amount of fuel for flight. Consequently, the overall capabilities of a near space vehicle are limited.

Future near space vehicles are also envisioned to be powered by batteries. For example, a near space vehicle can utilize a lithium battery to power its propulsion systems and onboard components. The current designs of battery powered near space vehicles are also limited by their endurance capabilities. A near space vehicle's duration of flight is dependent on the energy density and life of the battery.

Despite the various power technologies known in the art there remains a need for a near space vehicle powered by a system that assures improved endurance capabilities. A near space vehicle design is also needed that is able to function twenty four hours a day, seven days a week (24/7), providing coverage of a strategic location on the earth to various users. In order to accomplish such a near space vehicle design, an integrated, flexible system is needed for remote power generation. A power system is further needed that is capable of converting solar energy to both thermal energy and electric energy efficiently in air temperatures (e.g., −60° F.) of near space altitudes (e.g., 60,000 feet above sea level). In order to convert 40% or more of the sun's incident energy into electric power, different architectures are required.

### SUMMARY OF THE INVENTION

The invention concerns a system for generating electric power from solar energy. According to one embodiment, the system includes a thermal energy collector positioned for exposure to solar energy. A thermal energy converter is also provided. The thermal energy converter has one or more fluid couplings for communicating thermal energy to the thermal energy collector. The thermal energy converter is configured for converting thermal energy collected by the thermal energy collector to electric power. A power generation system is also provided. The power generation system receives electric power generated by the thermal energy converter. The power generation system is configured for generating a fuel and an oxidizer. The fuel and the oxidizer are used in a combustor to heat a working fluid during hours when insufficient solar energy is available to do so. The heated working fluid is then used during a night cycle to drive the same or similar electric power system elements as utilized during a day cycle.

The system makes use of a solar concentrator formed of an optically reflective material having a curved surface. A support means (such as a support structure) is provided for the solar concentrator that includes one or more movable portions for varying a position of the solar concentrator. The curved surface of the solar concentrator defines a focal center (or a focal line) toward which light incident on the curved surface is reflected. The thermal energy collector is positioned substantially at the focal center (or along the focal line). The thermal energy collector further includes one or more conduits containing a working fluid. During daylight hours, a fluid transport system continuously circulates the working fluid between the thermal energy converter and the thermal energy collector when the solar concentrator is exposed to solar radiation. The thermal energy converter includes an engine powered by the working fluid and can also include an electric generator powered by the engine.

According to one aspect of the invention, the solar concentrator, the thermal energy converter, and the power generation system can be operatively disposed in a vehicle. If the system is based in a vehicle, the vehicle can advantageously include a lift system configured for carrying the vehicle to a near space altitude. Accordingly, the thermal energy converter can include one or more heat exchangers arranged for transferring heat from a working fluid to the very cold exterior atmosphere surrounding the vehicle. The vehicle can also include a control system programmed to control a position of the vehicle and/or an orientation of the solar concentrator described herein. Accordingly, the solar concentrator can be constantly pointed towards a source of solar radiation.

According to one aspect of the invention, the power generation system includes an electrolysis system configured for electrolyzing a hydrogen-oxygen mix into a fuel and an oxidizer. Two or more storage vessels are also provided for storing the fuel and the oxidizer. A combustor is configured for combusting the fuel and the oxidizer to produce a reaction product. A heat exchanger is provided and configured for transferring heat from a reaction product to a working fluid. The heated working fluid is then used during a night cycle to drive a thermal energy converter. Advantageously, the thermal energy converter can be the same thermal energy converter used to generate electric power during daylight hours.

A separate heat exchanger is advantageously provided for transferring heat from the reaction product to an ambient air for the purposes of regenerating the source from which the fuel and the oxidizer are formed. For example, if the reaction product is heated water vapor, then water vapor can be condensed and stored in a liquid storage vessel so that the electrolysis process can be subsequently repeated.

According to an alternative embodiment, the invention includes a method for supplying electric power to a load. The method begins by exposing a thermal energy collector to a source of solar radiation. The method continues by generating electric power with a thermal energy converter using thermal energy collected by the thermal energy collector. Finally, a portion of the electric power generated by the thermal energy converter is provided to a power generation system. The power generation system uses the electric power to form a fuel and an oxidizer from a base product, such as water. The method also includes storing at least a portion of the fuel and the oxidizer that is generated during daylight hours when the system is operational. Subsequently, the fuel and the oxidizer thus formed are used to generate electricity during non-daylight hours.

According to an embodiment of the invention, the fuel and the oxidizer referred to herein can be hydrogen and oxygen, respectively. The fuel and the oxidizer can be combusted in a combustion process that generates a heated reaction product in the form of water vapor and heat. For example, the combusting step can include combusting a stoichiometric mixture derived from mixing the fuel and the oxidizer. Heat from the reaction product can be communicated to one or more working fluids. Thereafter, the method continues by converting thermal energy collected by the one or more working fluids to electric power. This can occur in a process similar to a Stirling cycle that includes powering an engine with the heated working fluid. This process can also include powering (or rotating) an electric generator with the engine.

For the purposes of generating electricity form solar energy during daylight hours, the method includes exposing to a source of solar radiation a solar concentrator formed of an optically reflective material. The reflective material is selected to have a curved surface that defines a focal center (or a focal line) toward which light incident on the curved surface is reflected. The thermal energy collector is advantageously positioned substantially at the focal center (or along the focal line). Thermal energy is communicated to a working fluid contained in a conduit of the thermal energy collector. Thereafter, the heated working fluid is used to power an engine in a process similar to a Stirling cycle. The process also includes generating electricity by any suitable means, such as by powering (or rotating) an electric generator with the engine.

The forgoing process can be advantageously used to continuously provide electric power to a load, during periods of daylight and non-daylight hours. For example, the system can be installed in a vehicle, in which case the load can include various onboard vehicle systems, including a propulsion system. If the vehicle is provided with a lift system, the process can advantageously include positioning the vehicle at a near space altitude (for example, 50,000 feet to 100,000 feet above sea level). Consequently, the power generation system can take advantage of a substantial temperature differential between the working fluid and a surrounding atmosphere at a near space altitude to power an engine. It should be appreciated that the ambient air at a near space altitude has a temperature of approximately negative sixty degrees Fahrenheit (−60° F.).

### BRIEF DESCRIPTION OF THE DRAWINGS

Embodiments will be described with reference to the following drawing figures, in which like numerals represent like items throughout the figures, and in which:

FIG. 1 is schematic illustration of a near space vehicle that is useful for understanding the invention.

FIG. 2 is a cross-sectional view of the near space vehicle of FIG. 1 taken along line 2-2.

FIG. 3 is a cross-sectional view of the near space vehicle of FIG. 1 taken along line 3-3.

FIG. 4 is a block diagram of a near space vehicle hardware architecture that is useful for understanding the invention.

FIG. 5 is a block diagram of a power system for a near space vehicle that is useful for understanding the invention.

FIG. 6 is an illustration that is useful for understanding the structure of a solar energy collector.

FIG. 7 is a cross-sectional view of the solar energy collector of FIG. 6 taken along line 7-7.

FIG. 8 is an illustration that is useful for understanding the structure of a solar energy collector array.

FIG. 9 is a schematic illustration of a thermal energy converter that is useful for understanding the invention.

FIG. 10 is a flow diagram illustrating a thermal energy conversion flow process that is useful for understanding the invention.

FIG. 11 is a flow diagram illustrating a thermal energy conversion flow process that is useful for understanding the invention.

FIG. 12 is a process flow diagram that is useful for understanding a method for powering a near space vehicle.

### DETAILED DESCRIPTION OF THE PREFERRED EMBODIMENTS

The invention concerns a system for generating electric power from solar energy. The system includes a solar energy collector that has a reflective surface. The reflective surface is a solar concentrator formed into a shaped surface for focusing solar radiation toward an elongated solar energy collection zone provided at a focal center (or along a focal line) defined by the reflective surface. An elongated thermal energy collector is positioned at the focal center (or along the focal line) within the solar energy collection zone. The thermal energy collector includes fluid conduits to provide passageways for the flow of a working fluid. The working fluid collects thermal energy as it flows through the thermal energy collector. The working fluid is used by a thermal energy converter to convert the thermal energy to electric power. In this regard, it should be appreciated that the working fluid goes through a thermal energy expansion process. A portion of the electric power generated by the thermal energy converter is supplied to a hydrogen-oxygen power generation system. The hydrogen-oxygen power generation system converts thermal energy into electric power. The foregoing arrangement results in a relatively simple system that converts solar energy to electric power with a high efficiency.

The power system described herein can be used to power any system, such as fixed and mobile systems used in terrestrial applications where there exists a cold thermal sink (such as, a cold stream). However, the power system is especially advantageous for use in powering a vehicle intended for high altitude flight operations where there exists an available thermal sink (such as, a cold ambient air). For example, the present invention can be implemented on a near space vehicle. One significant advantage of using the system in a near space vehicle application is the large temperature differential that is achieved between the heated working fluid and the very cold atmosphere that exists at near space altitudes. Accordingly, the following discussion describes the present invention in the context of a near space vehicle application. Still, it should be understood that this description is merely presented as one possible arrangement, and the invention is not limited in this regard.

Near Space Vehicle

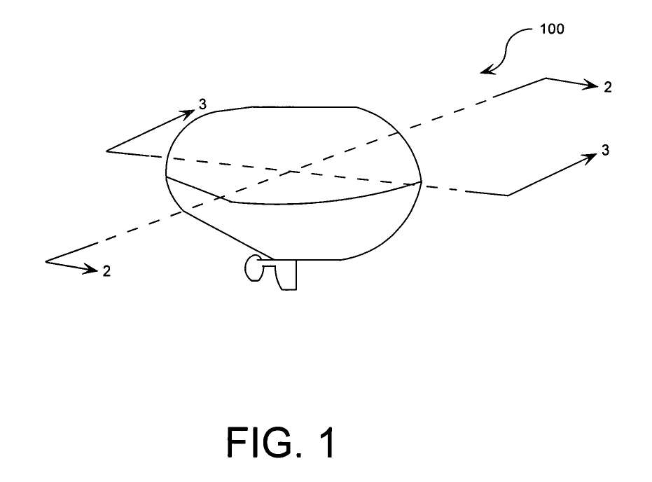

FIG. 1 is a schematic illustration of a near space vehicle 100 that is useful for understanding the invention. According to one embodiment of the invention, near space vehicle 100 can be an unmanned, solar powered airship that can maintain a geostationary position at near space altitudes ranging between 50,000 feet and 100,000 feet above sea level. However, the invention is not limited in this regard and the system can be used in other types of vehicles.

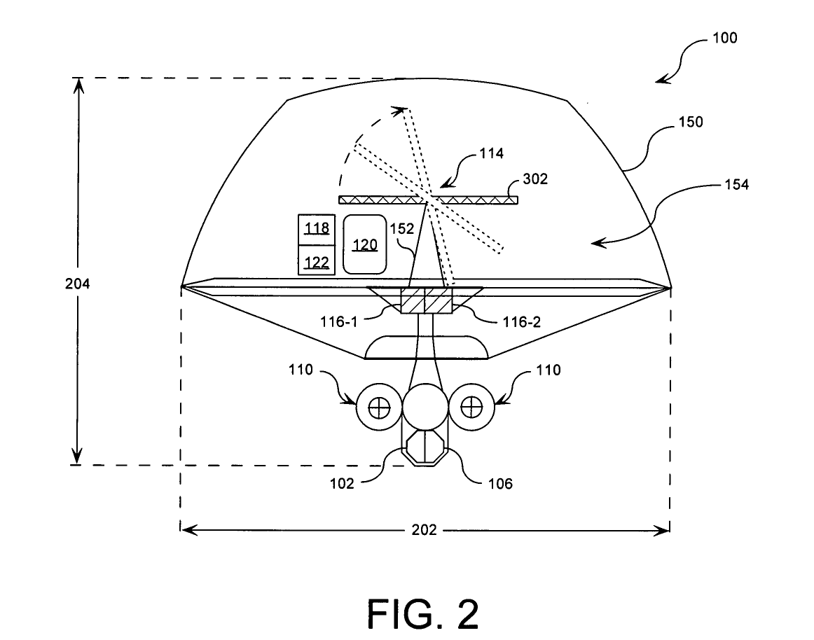

Referring now to FIG. 2, the near space vehicle 100 is comprised of a lift system 154 and a propulsion system 110. The near space vehicle 100 also includes a solar window 150, a solar energy collector 114, thermal energy converters 116-1, 116-2, a fluid storage device 120, an electrolysis system 118, and a combustor 122. The near space vehicle 100 can also include an imaging system 102 and a sensor system 106.

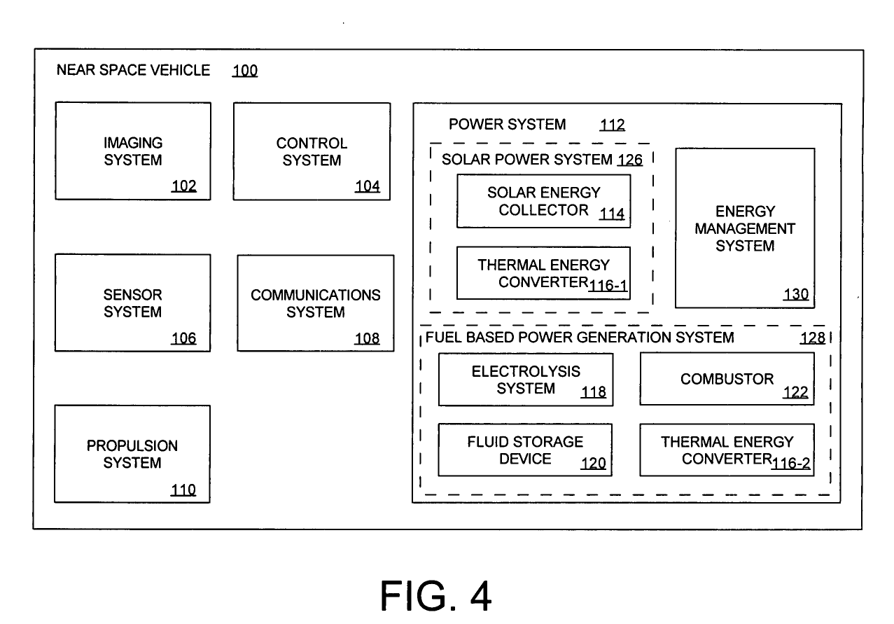

The lift system 154 provides lift to the near space vehicle 100. According to one embodiment of the invention, the lift system 154 is comprised of a lighter-than-air fluid (e.g., helium or hydrogen) contained in an interior vessel defined by near space vehicle 100. Propulsion system 110 controls the near space vehicle's direction of travel and can also control the vehicle's altitude (pitch, roll, and yaw). Propulsion system 110 is used for guiding a take off, guiding an ascent, guiding a decent, guiding a landing, and maintaining a geostationary position. For example, propulsion system 110 can be used to maintain a position where the solar energy collector constantly faces the sun. Propulsion system 110 will be described in great detail below (in relation to FIG. 4).

Solar window 150 provides an optical path which is used to expose solar energy collector 114 to a source of solar radiation (i.e. the sun). As such, the solar window 150 can be comprised of any optically transparent material suitable for operations at a near space altitude. Such materials can include transparent polymer films, glass or plastic without limitation.

Solar energy collector 114 is coupled to near space vehicle 100 by a support pedestal 152. Support pedestal 152 can be a light weight structure comprised of any material commonly used in the art, such as a metal, a metal alloy, a composite material, or a rigid polymer. The position of solar energy collector 114 can be adjusted by or in conjunction with support pedestal 152 such that a reflective surface 302 constantly faces the sun. For example, support pedestal 152 can be designed with a movable portion that forms an adjustment mechanism. The adjustment mechanism can include electronics, sensors, pivot joints, and servo-motors such that solar energy collector can be rotated and or pivoted about one or more axis. Such systems are well known in the art and can allow solar energy collector 114 to follow the movement of the sun.

According to another embodiment of the invention, an adjustment mechanism of support pedestal 152 can be used to place solar energy collector 114 in a sun pointing position. According to yet another embodiment of the invention, propulsion system 110 in conjunction with an adjustment mechanism of support pedestal 152 can be used to place solar energy collector 114 in a sun pointing position.

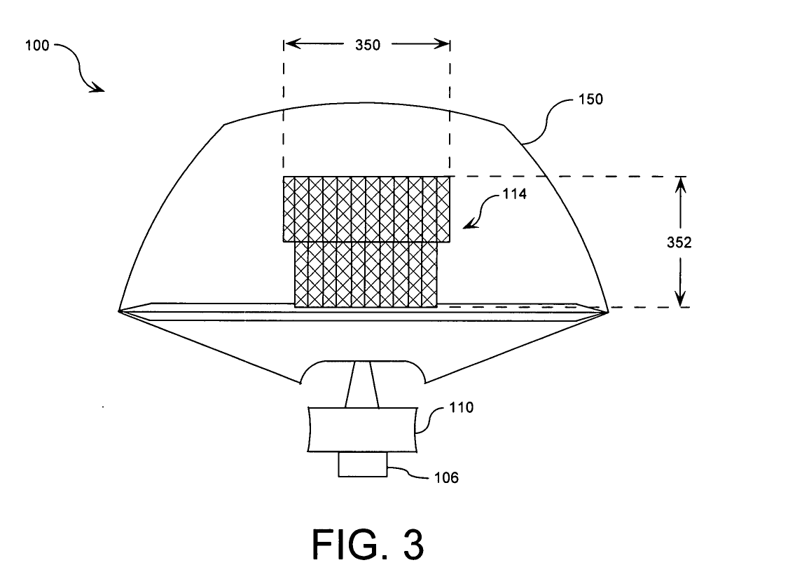

Referring now to FIG. 3, solar energy collector 114 has a height 352 and a length 350. A person skilled in the art will appreciate that height 352 and length 350 can be selected in accordance with a solar energy collector 114 application. For example, a desired electric power output of the solar power system can dictate the sizing of the solar energy collector 114.

Referring again to FIG. 2, the near space vehicle 100 has a height 204, a length 202, and a width (not shown). A person skilled in the art will appreciate that the height 204, the length 202, and the width (not shown) can be selected in accordance with a near space vehicle 100 application. For example, the size of the vehicle can be selected so that the vehicle provides sufficient lift for the power system described herein and some predetermined payload. The payload can be selected in accordance with a near space vehicle application. A person skilled in the art will also appreciate that the structure of the near space vehicle 100 can be comprised of any material used in the art for high altitude balloons and airships, such as lightweight, high-strength fabrics, films, and composite materials.

Also, a person skilled in the art will appreciate that the near space vehicle 100 architecture is one embodiment of an architecture in which the methods described below can be implemented. However, the invention is not limited in this regard and other suitable near space vehicle architectures can be used without limitation.

Near Space Vehicle Hardware Architecture

Referring now to FIG. 4, there is provided a block diagram of a near space vehicle hardware architecture that is useful for understanding the invention. As shown in FIG. 4, the near space vehicle 100 includes a power system 112, a propulsion system 110, and a control system 104. The near space vehicle 100 can also include an imaging system 102, a sensor system 106, and a communications system 108. For example, imaging system 102 can be comprised of a radar imaging system, a still camera, and/or a video camera for monitoring a strategic location on the earth. Control system 104 is advantageously comprised of one or more microprocessors programmed for controlling navigation of the near space vehicle 100 from a central location. Control system 104 can also be comprised of one or more microprocessors programmed for controlling the position of near space vehicle 100 by controlling the operation of propulsion system 110. Control system 104 can also be comprised of one or more microprocessors programmed for controlling an orientation of solar energy collector 114. Such control can include controlling an adjustment mechanism of support pedestal 152 such that the solar energy collector 114 constantly points in towards a source of solar radiation.

Propulsion system 110 can include a motor that is powered by electricity. Communications system 108 can be comprised of an antenna element, a radio transceiver, and/or a radio receiver. The components of the communications system are well known to persons skilled in the art. Thus, the listed components will not be described in detail herein.

Power system 112 is comprised of a solar power system 126, a fuel based power generation system 128, and an energy management system 130. Solar power system 126 is comprised of the solar energy collector 114 and a thermal energy converter 116-1 for providing optimized solar energy conversion whereby directly converting photons to electrical power and supplying the same to the near space vehicle 100. Solar power system 126 converts solar energy into a sufficient amount of electrical power to support near space vehicle's 100 propulsion system 110 and/or electrical systems 102,104, 106, 108. Fuel based power generation system 128 (also herein referred to as a fuel generation system) is comprised of a system for generating an oxidizer and a fuel. For example, an electrolysis system 118 can be used for this purpose. The fuel based power generation system 128 also includes a fluid storage device 120, a combustor 122, and a thermal energy converter 116-2. Fuel based power generation system 128 converts heat energy into a sufficient amount of electrical power to support near space vehicle's 100 propulsion system 110 and/or electrical systems 102, 104, 106, 108. According to one embodiment, the solar power system 126 in concert with the fuel based power generation system 128 can provide a continuous output of electrical power twenty four (24) hours a day, seven (7) days a week, such that the near space vehicle can operate at a high altitude for an extended period of time (i.e., days, weeks, or months). Power system 112 will be described in further detail below.

A person skilled in the art will further appreciate that near space vehicle 100 hardware architecture is one embodiment of a hardware architecture in which the apparatus and methods described below can be implemented. However, the invention is not limited in this regard and other suitable near space vehicle hardware architectures can be used without limitation. For example, a single thermal energy converter can be used in place of thermal energy converters 116-1, 116-2.

System For Powering A Near Space Vehicle

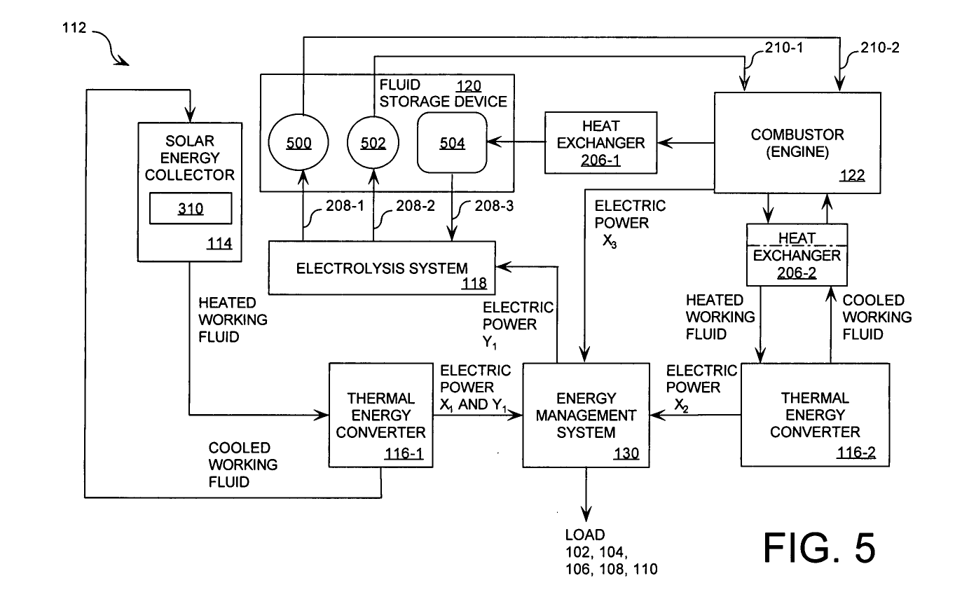

FIG. 5 is a block diagram of a power system that is useful for understanding the invention. As shown in FIG. 5, power system 112 is comprised of solar energy collector 114, thermal energy converters 116-1, 116-2, heat exchangers 206-1, 206-2, electrolysis system 118, fluid storage device 120, combustor 122, and energy management system 130. Solar energy collector 114, described in detail below, is coupled to thermal energy converter 116-1. Solar energy collector 114 is comprised of a thermal energy collector 310 including a working fluid to collect thermal energy from solar radiation. The working fluid is circulated through the thermal energy collector 310 and the thermal energy converter 116-1. The working fluid is heated as it circulates through the thermal energy collector 310. The heated working fluid passes through thermal energy converter 116-1 to generate electric power. One embodiment of the present invention uses a low vapor state liquid as the working fluid. In the thermal energy collector 504, a liquid working fluid is transformed into a gaseous working fluid by means of latent heat vaporization. The thermal energy converter 116-1 is electrically connected to electrolysis system 118 through the energy management system 130. The thermal energy converter 116 can supply the electrolysis system 118 with all or a portion of its generated electric power for electrolyzing a liquid (e.g., water H₂O) into a fuel (e.g., hydrogen H₂) and an oxidizer (e.g., oxygen O₂). In this regard, it should be appreciated that the electric power Y₁ supplied by the thermal energy converter 116-1 to the electrolysis system 118 is controlled by the energy management system 130.

Similarly, the thermal energy converter 116-1 is electrically connected to the energy management system 130 and can supply the energy management system 130 with all or a portion of the electric power it generates for powering the propulsion system 110 and/or the electrical systems 102, 104, 106, 108. In this regard, it should be appreciated that the energy management system 130 is part of an electric power distribution system that includes one or more circuits configured for distributing power to one or more systems onboard the near space vehicle 100. For example, energy management system 130 can direct power to propulsion system 110 and/or electrical systems 102, 104, 106, 108. Energy management systems are well known to persons skilled in the art. Thus, energy management systems will not be described in detail herein.

Electrolysis system 118 electrolyzes a liquid (e.g., water) into two or more gases (e.g., a hydrogen gas and an oxygen gas). For example, water (H₂O) can be chemically reduced into the constituent hydrogen (H₂) and oxygen (O₂) with added electricity:

H₂O+(e⁻)→H₂+0.5 O₂

This process is called electrolysis. Thermal energy converter 116-1 supplies the required electrical power for to electrolysis system 118. Electrolysis systems are well known to persons skilled in the art. Thus, electrolysis systems will not be described in great detail herein.

Electrolysis system 118 is coupled to fluid storage device 120. Fluid storage device 120 is comprised of a liquid vessel 504 for storing a liquid (e.g., water H₂O), a fuel vessel 500 for storing a fuel (e.g., hydrogen H₂), and an oxidizer vessel 502 for storing an oxidizer (e.g., oxygen O₂). A fluid transport system is disposed between the electrolysis system 118 and the fluid storage device 120. The fluid transport system is comprised of one or more fluid conduits 208-3 for communicating the liquid from the fluid storage device 120 to the electrolysis system 118. The fluid transport system is comprised of one or more fluid conduits 208-1, 208-2 for communicating the fuel and the oxidizer from the electrolysis system 118 to the fluid storage device 120.

Fluid storage device 120 is also coupled to combustor 122. A fluid transport system is disposed between the fluid storage device 120 and the combustor 122. The fluid transport system is also comprised of one or more fluid conduits 210-1, 210-2 for communicating the fuel and the oxidizer from the fluid storage device 120 to the combustor 122.

Combustor 122 can be a combustion engine, such as a constant pressure combustion engine, a constant volume combustion engine, or a catalytic combustor. Combustor 122 mixes the fuel and oxidizer to form a stoichiometric mixture (i.e., a fuel-to-oxidizer ratio that can result in a complete combustion). Thereafter, combustor 122 burns the mixture to produce a reaction product (e.g., heated water vapor). Combustors 122 are well known to persons skilled in the art. Thus, combustors will not be described in detail herein. However, it should be appreciated that the combustor 122 can be used as an engine, such as a turbine engine or a piston engine having an electrical generator coupled thereto. In this regard, the combustor 122 is coupled to the energy management system 130 such that the combustor 122 can directly supply the energy management system 130 with all or a portion of the electric power X₃ that it generates.

Combustor 122 is coupled to heat exchanger 206-1. The reaction product of combustor 122 is passed to heat exchanger 206-1 such that the vaporous reaction product (e.g., liquid water H₂O) is cooled to become a liquid (e.g., liquid water H₂O). This cooling process is performed for the purposes of regenerating the source from which the fuel and the oxidizer are formed. Heat exchanger 206-1 takes advantage of the cold ambient air (e.g., −60° F.) for use as a coolant. This ambient cold air is essentially in infinite supply at near space altitudes. After circulating through heat exchanger 206-1, the liquid is communicated from heat exchanger 206-1 to liquid vessel 504 for storage. The stored liquid (e.g., liquid water H₂O) is used by the electrolysis system 118 to repeat the electrolysis process described above (i.e., generate a fuel and an oxidizer). In this regard, the electrolysis system 118, the combustor 122, the fluid storage device 120, and the heat exchanger 206-1 provide a closed loop system. Heat exchangers are well known to persons skilled in the art. Thus, heat exchangers will not be described in great detail herein.

Combustor 122 is also coupled to heat exchanger 206-2. The reaction product of the combustion process described above flows across the exterior of heat exchanger 206-2 such that thermal/heat energy is transferred from the reaction product to a working fluid circulating through the fluid conduits. The heated working fluid then passes to thermal energy converter 116-2 to generate electric power. Thermal energy converter 116-2 can supply energy management system 130 with all or a portion of the electric power it generates.

Power system 112 can be designed to support all of the power requirements of the near space vehicle 100. A near space vehicle's propulsion system 110 and electrical systems 102, 104, 106, 108 require X kilowatts (where, X═X₁+X₂+X₃) of electric power for operation. The electrolysis system 118 requires Y kilowatts (where, Y=Y₁) of electric power to fully electrolyze a liquid into two or more gases during daylight hours. The solar energy collector 114 can be designed to collect a sufficient amount of solar energy such that thermal energy converter 116-1 outputs Y₁+X₁ kilowatts of electric power. The fuel based power generation system 128 can be designed such that the thermal energy converter 116-2 outputs X₂ kilowatts of electric power and/or the combustor 122 outputs X₃ kilowatts of electric power. A person skilled in the art will appreciate that the electric power generated by the thermal energy converters 116-1, 116-2 and/or the combustor 122 can be managed in accordance with a near space vehicle application (i.e., all or a portion of the electric power generated from the thermal energy converter 116-1 can be supplied to electrolysis system 118 and/or energy management system 130; all or a portion of the electric power generated from thermal energy converter 116-2 and/or the combustor 122 can be supplied to energy management system 130).

According to an embodiment of the invention, near space vehicle's propulsion system 110 and electrical systems 102, 104, 106, 108 require X kilowatts (where, X=X₁) of electric power for operation during a day cycle. In such a scenario, the thermal energy converter 116-2 and/or the combustor 122 do not output electric power. Accordingly, X₂ and X₃ equal zero kilowatts. However, thermal energy converter 116-1 generates a sufficient amount of electric power to support propulsion system 110 and electrical systems 102, 104, 106, 108 continuously throughout the day cycle.

According to another embodiment of the invention, near space vehicle's propulsion system 110 and electrical systems 102, 104, 106, 108 require X kilowatts (where, X=X₂+X₃) of electric power for operation during a night cycle. In such a scenario, the thermal energy converter 116-1 does not output electric power. Accordingly, X₁ equals zero kilowatts. However, the thermal energy converter 116-2 and/or the combustor 122 generate a sufficient amount of electric power to support the propulsion system 110 and the electrical systems 102, 104, 106, 108 continuously throughout the night cycle.

A person skilled in the art will appreciate that power system 112 architecture is one embodiment of a power system architecture having a solar energy collector 114 in which the methods described below can be implemented. However, the invention is not limited in this regard and other suitable power system architectures can be used without limitation. For example, a single thermal energy converter can be used in place of thermal energy converters 116-1, 116-2.

Solar Energy Collector

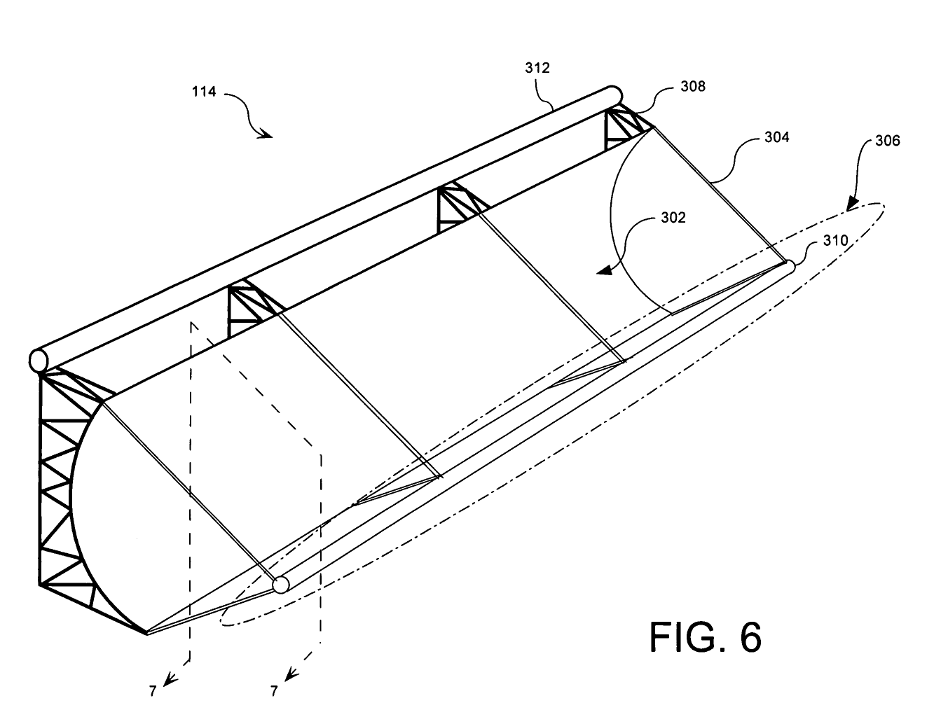

Referring now to FIG. 6, solar energy collector 114 is comprised of a reflective surface 302 and a solar energy collection zone 306. Reflective surface 302 is a solar concentrator formed into a shaped surface for focusing solar radiation. The shaped surface can concentrate solar energy, at an intensity greater than its incident intensity, toward the solar energy collection zone 306 when the reflective surface is exposed to sunlight. In the embodiment shown in FIG. 6, the solar energy collection zone 306 is advantageously disposed substantially at a focal center (or along a focal line) of the reflective surface. According to one embodiment, the reflective surface 302 has a linear parabolic shape as shown in FIG. 6. However, the invention is not limited in this regard. Any other suitably shaped surface can be used for focusing solar energy toward the collection zone 306 provided that it has the ability to concentrate solar energy to a sufficient extent required for a particular application. Reflective surface 302 can be comprised of a reflective material commonly used in the art, such as a reflective film (e.g., aluminized film), mylar or a silvered glass.

According to an embodiment of the invention, reflective surface 302 is formed into a shape for concentrating solar radiation. For example, the reflective surface 302 can concentrate solar energy up to two hundred (200) times its incident intensity depending upon the arrangement of the reflective surface and the measured location within the collection zone 306 (i.e., have up to a 200:1 concentration ratio). Still, a person skilled in the art will appreciate that the invention is not limited in this regard. The concentration ratio can be selected in accordance with a solar energy collector 114 application.

Thermal energy collector 310 is fixed in a position at the focus of the shaped reflective surface 302. For example, the thermal energy collector 310 can be maintained in this position by means of a rigid frame 304. Those skilled in the art will appreciate that only a portion of the thermal energy collector 310 can be positioned precisely at the focal center (or on the focal line) of the reflective surface 302 so as to receive a highest concentration of solar energy. Those portions of the thermal energy collector 310 which are positioned away from this focal center (or focal line) will receive a somewhat lower concentration of solar energy. Consequently, the concentration ratio of thermal energy can vary somewhat. For example, the concentration ratio for an embodiment of the present invention can vary between about 20:1 to 50:1 over the surface of the thermal energy collector 310. Notably, a shaped surface having a focal center (or a focal line) can advantageously provide a sufficient amount of heat at the thermal energy collector 310 to create a large temperature differential between the thermal energy collector 310 and the near space atmosphere.

Rigid frame 304 can be made from any material commonly used in the art, such as a metal, metal alloy, composite, fiber reinforced plastic, or polymer material. Rigid frame 304 is coupled to a support structure 308. Support structure 308 can be attached to truss tube 312. Support structure 308 is also coupled to support pedestal 152 of near space vehicle 100, such that reflective surface 302 faces the sun during daylight hours.

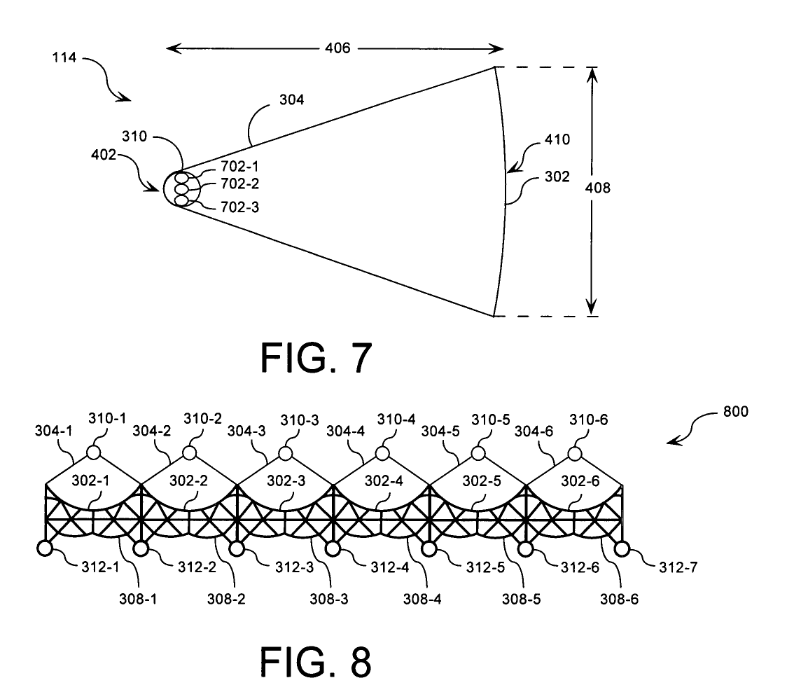

Referring now to FIG. 7, a cross-sectional view of the solar energy collector 114 is provided. Solar energy collector 114 has a width 406. Reflective surface 302 has a height 408. Reflective surface 302 is comprised of a curved surface having a curvature 410. Thermal energy collector 310 has a diameter 402. Width 406, height 408, curvature 410, and diameter 402 can be selected in accordance with a solar energy collector 114 application. For example, a desired electric power output of the solar power system 126 can dictate the sizing of the reflective surface 302 and the thermal energy collector 310.

As shown in FIG. 7, thermal energy collector 310 is comprised of one or more fluid conduits 702-1, 702-2, 702-3 to provide passageways for the flow of a working fluid. The flow of the working fluid through the one or more fluid conduits 702-1, 702-2, 702-3 can be produced by compressing the fluid before it enters the fluid conduits 702-1, 702-2, 702-3. As the working fluid is heated by solar energy, it can change from a liquid state to a gaseous state. Alternatively, mechanical means (e.g., a circulating pump or a fan) can be used to create flow of the working fluid through the fluid conduits 702-1, 702-2, 702-3. The fluid conduits 702-1, 702-2, 702-3 can be comprised of any material that is a good thermal conductor capable of constraining the fluid.

Referring now to FIG. 8, it will be appreciated that instead of using just one solar energy collector 114, two or more solar energy collectors 114 can be arranged in rows and/or columns to form an array 800. Array 800 can be comprised of support structures 308-1, 308-2, 308-3, 3084, 308-5, and 308-6. The support structures can be attached to truss tubes 312-1, 312-2, 312-3, 3124, 312-5, 312-6, and 312-7. The support structures can support reflective surfaces 302-1, 302-2, 302-3, 3024, 302-5, and 302-6. Further, a set of rigid frames 304-1, 304-2, 304-3, 3044, 304-5, 304-6 attached to the support structures can be used to position a plurality of thermal energy collectors 310-1, 310-2, 310-3, 3104, 310-5, 310-6.

A person skilled in the art will appreciate that the solar energy collector 114 architecture of FIG. 6, FIG. 7, and FIG. 8 is one embodiment of a solar energy collector in which the methods described below can be implemented. However, the invention is not limited in this regard and other suitable solar energy collector architectures can be used without limitation.

Thermal Energy Converter and Thermal Energy Flow Process

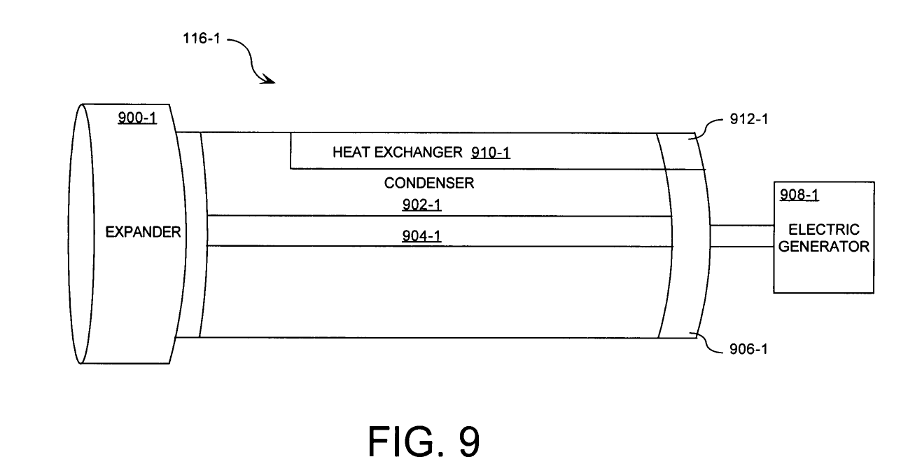

FIG. 9 is a schematic illustration of a thermal energy converter 116-1 according to an embodiment of the invention. Thermal energy converter 116-2 can have a similar construction and for that reason will not be described herein in detail. Alternatively, a single thermal energy converter can take the place of thermal energy converters 116-1, 116-2. Referring again to FIG. 9, thermal energy converter 116-1 is an engine comprised of an expander 900-1, a condenser 902-1, a shaft 904-1, compressors 906-1 and 912-1, and an electric generator 908-1. Expander 900-1, driven by a flow of a working fluid, is coupled to shaft 904-1 such that expander 900-1 rotates shaft 904-2. Expander 900-1 can be a type of expander capable of extracting work from the flow of the working fluid (e.g., a steam engine). Shaft 904-1 drives electric generator 908-1 to produce electric power from mechanical energy. Condenser 902-1 converts a working fluid from a gas to a liquid (i.e., removes heat from the working fluid). Condenser 902-1 is comprised of a heat exchanger 910-1 configured for transferring thermal energy from the working fluid circulating through heat exchanger 910-1 to a very cold ambient air (e.g., −60° F.) flowing across its outer surface. Notably, this ambient air is essentially in infinite supply at near space altitudes (e.g., 60,000 feet above sea level). Compressor 912-1 compresses the working fluid after it flows through heat exchanger 910-1. Compressor 906-1 also compresses the working fluid to reduce its volume.

According to an embodiment of the invention, thermal energy converters 116-1, 116-2 can be advantageously selected to produce electric power at a high efficiency rate. For example, using current technology thermal energy converters 116-1, 116-2 can provide for a power conversion efficiency of about fifty (50) percent. Still, a person skilled in the art will appreciate that the invention is not limited in this regard. Thermal energy converters 116-1, 116-2 can produce electric power at an efficiency rate consistent with available current technology that is in accordance with a particular power system 112 application.

A person skilled in the art will appreciate that the thermal energy converter 116-1, 116-2 architecture is one embodiment of a thermal energy converter architecture in which the methods described below can be implemented. However, the invention is not limited in this regard and other suitable thermal energy converter architectures can be used without limitation, provided that it operates with a relatively high degree of efficiency. Also, it should be appreciated that a single thermal energy converter can be used in place of thermal energy converters 116-1, 116-2.

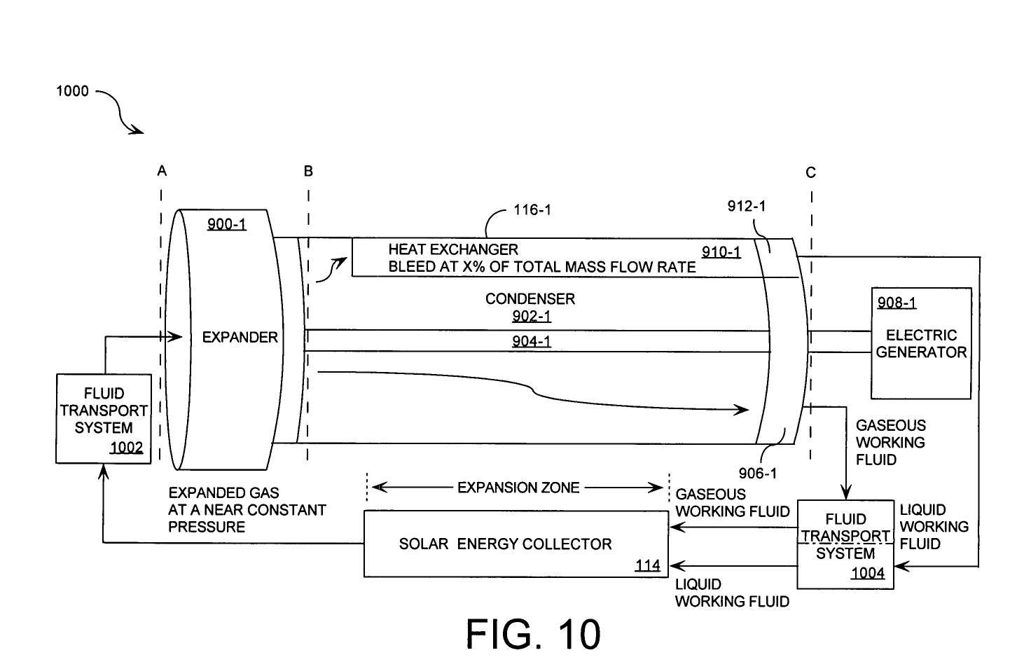

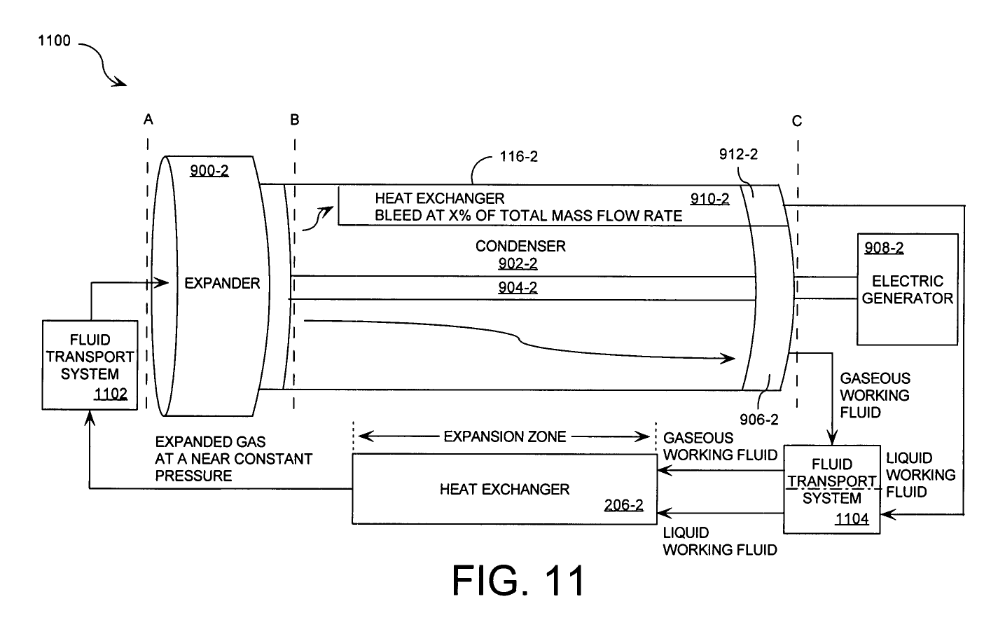

Referring now to FIG. 10 and FIG. 11, a thermal energy conversion flow process 1000, 1100 is provided that utilizes thermal energy converter 116-1, 116-2 in a heat transfer cycle (for example, a Stirling cycle) for the conversion of thermal/heat energy into electric power. A Stirling cycle is well known and involves heating a working fluid to increase its pressure and create a fluid motive drive pressure. The pressurized working fluid flows through an expander to create work. Subsequently, the working fluid is cooled to decrease its pressure and create a constant fluid flow through the expander.

Referring to FIG. 10, there is illustrated a thermal energy conversion flow process 1000 which includes thermal energy converter 116-1. The process begins when a working fluid circulates under pressure through solar energy collector 114. As the pressurized working fluid circulates through solar energy collector 114, thermal energy is transferred to the working fluid. This transfer of thermal energy causes a change in the state of the working fluid from a liquid state to a gaseous state which results in an expansion of the working fluid. After changing state, the working fluid flows towards the fluid transport system 1002. Fluid transport system 1002 (e.g., a pipeline) communicates the pressurized working fluid from solar energy collector 114 to thermal energy converter 116-1. The working fluid enters thermal energy converter 116-1 at point A where the motive drive pressure equals P1. As the gaseous working fluid flows through thermal energy converter 116-1, the expander 900-1 is driven by the large volumetric flow of the pressurized working fluid such that it rotates shaft 904-1. Shaft 904-1 drives electrical generator 908-1 to produce electric power. After flowing through the expander 900-1, a portion of the gaseous working fluid continues to flow to condenser 902-1. This gaseous working fluid then flows to compressor 906-1 where its volume is reduced. The working fluid exits compressor 906-1 at point C where the motive drive pressure equals a value that is slightly higher than P1. Subsequently, the pressurized working fluid flows into a fluid transport system 1004 (for example, a pipeline for a gaseous working fluid). The fluid transport system 1004 communicates the gaseous working fluid from the compressor 906-1 to the solar energy collector 114.

The remaining portion of the gaseous working fluid flows into the heat exchanger 910-1 which can use the cold ambient air as a coolant. Heat exchanger 910-1 is configured to transfer (i.e., bleed) thermal energy from the working fluid at X% of the fluids mass flow rate. This process results in a pressure drop from point A to point B, i.e., the motive drive pressure at point A equals P1 and the motive drive pressure at point B equals P2 where P2 equals P1-X% bleed. It should be understood that the bleed of the working fluid is the portion of the gaseous working fluid allowed to be condensed to a liquid working fluid. The pressure drop between point A and point B contributes to the constant fluid flow through the expander 900-1. The liquid working fluid then flows to compressor 912-1 where its volume can be reduced. The working fluid exits compressor 912-1 at point C where the motive drive pressure equals a value that is slightly higher than P1. Subsequently, the working fluid flows into a fluid transport system 1004 (for example, a pipeline for a liquid working fluid). The fluid transport system 1004 communicates the liquid working fluid from the compressor 912-1 to the solar energy collector 114 where the liquid working fluid mixes with the gaseous working fluid and where the liquid working fluid changes from a liquid state to a gaseous state.

A person skilled in the art will further appreciate that the thermal energy conversion flow process 1000 is one embodiment of the invention. However, the invention is not limited in this regard and any other suitable thermal energy converter flow process can be used without limitation to generate electricity. Specifically, it should be appreciated that any heat transfer cycle can be used with the present invention. In this regard, any Stirling cycle can also be used with the present invention.

Referring now to FIG. 11, there is shown a thermal energy conversion flow process 1100 that includes thermal energy converter 116-2. The process begins when a working fluid circulates under pressure through heat exchanger 206-2. As the pressurized working fluid circulates through heat exchanger 206-2, thermal energy is transferred to the working fluid. This transfer of thermal energy causes a change in the state of the working fluid from a liquid state to a gaseous state which causes an expansion of the working fluid. After changing state, the working fluid flows towards the fluid transport system 1102. Fluid transport system 1102 (e.g., a pipeline) communicates the pressurized working fluid from heat exchanger 206-2 to thermal energy converter 116-2. The working fluid enters thermal energy converter 116-2 at point A where the motive drive pressure equals P1. As the gaseous working fluid flows through the thermal energy converter 116-2, the expander 900-2 is driven by the large volumetric flow of the pressurized working fluid such that it rotates shaft 904-2. Shaft 904-2 drives electrical generator 908-2 to produce electric power. After flowing through the expander 900-2, a portion of the gaseous working fluid continues to flow to condenser 902-2. This gaseous working fluid then flows to compressor 906-2 where its volume can be reduced. The working fluid exits the compressor 906-2 at point C where the motive drive pressure equals a value that is slightly higher than P1. Subsequently, the pressurized working fluid flows into a fluid transport system 1104 (for example, a pipeline for a gaseous working fluid). The fluid transport system 1104 communicates the gaseous working fluid from the compressor 906-2 to the heat exchanger 206-2.

The remaining portion of the gaseous working fluid flows into the heat exchanger 910-2 which can use the cold ambient air as a coolant. The heat exchanger 910-2 is configured to transfer (i.e., bleed) thermal energy from the working fluid at X% of the fluids mass flow rate. This process results in a pressure drop from point A to point B, i.e., the motive drive pressure at point A equals P1 and the motive drive pressure at point B equals P2 where P2 equals P1-X% bleed. It should be understood that the bleed of the working fluid is the portion of the gaseous working fluid allowed to be condensed into a liquid working fluid. The pressure drop between point A and point B contributes to the constant fluid flow through the expander 900-2. The liquid working fluid then flows to compressor 912-2 where its volume can be reduced. The working fluid exits compressor 912-2 at point C where the motive drive pressure equals a value that is slightly higher than P1. Subsequently, the pressurized working fluid flows into a fluid transport system 1104 (for example, a pipeline for a liquid working fluid). The fluid transport system 1104 communicates the liquid working fluid from the compressor 912-2 to the heat exchanger 206-2 where the liquid working fluid mixes with gaseous working fluid and where the liquid working fluid changes from a liquid state to a gaseous state.

A person skilled in the art will further appreciate that the thermal energy conversion flow process 1100 is one embodiment of the invention. However, the invention is not limited in this regard and any other suitable thermal energy converter flow process can be used without limitation to generate electricity. Specifically, it should be appreciated that any heat transfer cycle can be used with the present invention. In this regard, any Stirling cycle can also be used with the present invention.

According to an embodiment of the invention, the working fluid used in the flow processes 1000, 1100 is selected to include a low vapor state working fluid. For example, the working fluid can be comprised of propane C₃H₈, ammonia NH₃, and butane C₄H₁₀. The working fluid can also be selected as a hydrocarbon. Still, a person skilled in the art will appreciate that the invention is not limited in this regard. Working fluid can be selected in accordance with the thermal gradient between the solar energy collector 114 and the heat exchanger 910-1, 910-2.

Method for Powering a Near Space Vehicle

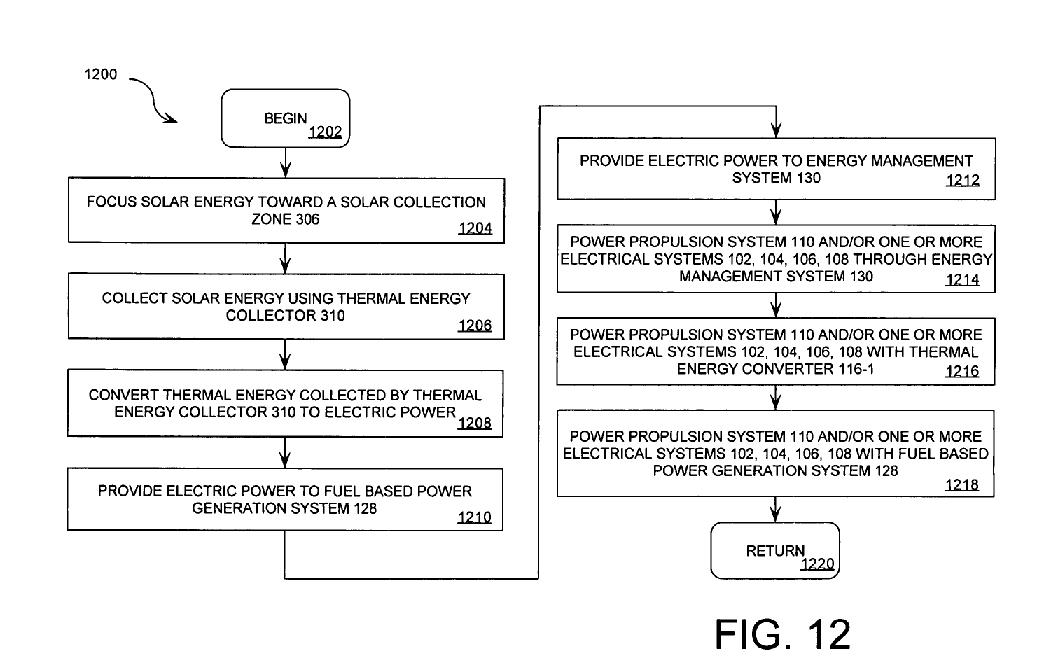

FIG. 12 is a process flow diagram illustrating a method for powering a near space vehicle using power system 112 of FIG. 4 and FIG. 5. Method 1200 begins with step 1202 and continues with step 1204. In step 1204, solar energy is focused towards a solar collection zone 306. In step 1206, solar energy is collected using thermal energy collector 310. The solar energy collected by thermal energy collector 310 is converted into electric power is step 1208. This step can involve transferring thermal energy from thermal energy collector 310 to a working fluid. The working fluid can be transported from thermal energy collector 310 to a thermal energy converter 116-1 for conversion of thermal energy into electric power. After converting thermal energy into electric power, control is passed to step 1210. In step 1210, electric power is provided to fuel based power generation system 128. Also, electric power is provided to energy management system 130 in step 1212. After providing electric power to energy management system 130, method 1200 continues with step 1214 where electric power is supplied to propulsion system 110 and/or one or more electrical systems 102, 104, 106, 108 through energy management system 130. Subsequently, control is passed to step 1216 where propulsion system 110 and/or one or more electrical systems 102, 104, 106, 108 are powered with the electric power generated by thermal energy converter 116-1. Propulsion system 110 and/or one or more electrical systems 102, 104, 106, 108 are also powered with the fuel based power generation system 128. After supplying power to propulsion system 110 and/or one or more electrical systems 102, 104, 106, 108, step 1220 is performed where method 1200 returns to step 1202.

A person skilled in the art will appreciate that method 1200 is one embodiment of a method for powering a near space vehicle 100 using a solar power system 126 and a fuel based power generation system 128. However, the invention is not limited in this regard and any other suitable method for powering a near space vehicle using a solar power device and a fuel based power generation system can be used without limitation.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A system for supplying electric power to a load, comprising:
a thermal energy collector positioned for exposure to solar energy;
a thermal energy converter having at least one fluid coupling to said thermal energy collector, and configured for converting thermal energy collected by said thermal energy collector to electric power; and
a power generation system provided with electric power generated by said thermal energy converter, said power generation system configured for generating a fuel and an oxidizer.

2. The system according to claim 1, further comprising a solar concentrator formed of an optically reflective material having a curved surface, said curved surface defining a focal center or a focal line toward which light incident on said curved surface is reflected; and wherein said thermal energy collector is positioned substantially at said focal center or along said focal line.

3. The system according to claim 2, wherein said thermal energy collector comprises at least one fluid conduit containing a working fluid.

4. The system according to claim 3, wherein said at least one fluid coupling further comprises a fluid transport system for continuously circulating said working fluid between said thermal energy converter and said thermal energy collector when said solar concentrator is exposed to solar radiation.

5. The system according to claim 4, wherein said thermal energy converter further comprises an engine powered by said working fluid.

6. The system according to claim 5, wherein said thermal energy converter further comprises an electric generator powered by said engine.

7. The system according to claim 2, further comprising a support means for said solar concentrator, said support means comprising at least one movable portion for varying a position of said solar concentrator.

8. The system according to claim 2, wherein said solar concentrator, said thermal energy collector, said thermal energy converter, and said power generation system are operatively disposed on a vehicle.

9. The system according to claim 8, wherein said vehicle comprises a lift system configured for carrying said vehicle to a near space altitude.

10. The system according to claim 9, wherein said thermal energy converter further comprises at least one heat exchanger arranged for transferring heat from a working fluid to an atmosphere surrounding said vehicle.

11. The system according to claim 10, further comprising a control system programmed to control a position of said vehicle and an orientation of said solar concentrator, so that said solar concentrator is constantly pointed towards a source of solar radiation.

12. The system according to claim 1, wherein said power generation system further comprises an electrolysis system configured for electrolyzing a hydrogen-oxygen mix into a fuel and an oxidizer with added electricity.

13. The system according to claim 1, further comprising a plurality of storage vessels for storing a water, said fuel, and said oxidizer.

14. The system according to claim 13, further comprising a combustor configured for combusting said fuel and said oxidizer to produce a reaction product.

15. The system according to claim 14, further comprising a first heat exchanger configured for cooling said reaction product by transferring heat from a reaction product to an ambient air.

16. The system according to claim 15, further comprising a liquid storage vessel for said cooled reaction product.

17. The system according to claim 16, further comprising a fluid transport system for communicating said cooled reaction product from said liquid storage vessel to said electrolysis system.

18. The system according to claim 17, further comprising a second heat exchanger configured for transferring heat from said reaction product to a working fluid.

19. A method for supplying electric power to a load, comprising:
exposing to a source of solar radiation a thermal energy collector;
generating electric power with a thermal energy converter using thermal energy collected by said thermal energy collector;
supplying said electric power to a power generation system; and
generating a fuel and oxidizer with said power generation system.

20. The method according to claim 19, further comprising storing at least a portion of said fuel and said oxidizer that is generated during daylight hours.

21. The method according to claim 19, further comprising using said fuel and said oxidizer to generate electricity during non-daylight hours.

22. The method according to claim 19, further comprising exposing to a source of solar radiation a concentrator formed of an optically reflective material having a curved surface that defines a focal center or a focal line toward which light incident on said curved surface is reflected; and positioning substantially at said focal center or along said focal line said thermal energy collector.

23. The method according to claim 19, further comprising heating at least one working fluid contained within a fluid conduit of said thermal energy collector.

24. The method according to claim 23, further comprising powering an engine with said at least one working fluid.

25. The method according to claim 24, further comprising powering an electric generator with said engine.

26. The method according to claim 19, wherein said generating a fuel and oxidizer step further comprises electrolyzing a hydrogen-oxygen mix.

27. The method according to claim 19, further comprising combusting said fuel and said oxidizer.

28. The method according to claim 27, further comprising combusting a stoichiometric mixture derived from mixing said fuel and said oxidizer.

29. The method according to claim 27, further comprising communicating heat from said reaction product derived from said combusting step to at least one working fluid.

30. The method according to claim 27, further comprising communicating heat from said reaction product derived from said combusting step to an ambient air.

31. The method according to claim 30, further comprising storing said reaction product in a storage vessel.

32. The method according to claim 31, further comprising communicating said reaction product from said storage vessel to said power generation system for generating said fuel and said oxidizer.

33. The method according to claim 27, further comprising continuously providing to a load electric power derived from said thermal energy collector, said thermal energy converter, and said combusting step.

34. The method according to claim 33, further comprising selecting said load to comprise a vehicle.

35. The method according to claim 34, further comprising positioning said vehicle at a near space altitude.

36. The method according to claim 35, further comprising using a temperature differential between a working fluid and a surrounding atmosphere at said near space altitude to power an engine.
